(19) United States
(12) Patent Application Publication
(10) Pub. No.: US 2026/0229411 A1
(43) Pub. Date: Aug. 6, 2026

(54) MULTILAYER CERAMIC CAPACITOR

(71) Applicant: Murata Manufacturing Co., Ltd., Nagaokakyo-shi (JP)

(72) Inventor: Yukie WATANABE, Nagaokakyo-shi (JP)

(21) Appl. No.: 19/636,038

(22) Filed: Apr. 1, 2026

Related U.S. Application Data
(63) Continuation of application No. PCT/JP2024/044426, filed on Dec. 16, 2024.

(30) Foreign Application Priority Data
Feb. 13, 2024 (JP) 2024-019143

(51) Int. Cl. H01G 4/232; H01G 4/30

(52) U.S. Cl. CPC H01G 4/232; H01G 4/30

(57) ABSTRACT

A multilayer ceramic capacitor includes a multilayer body, a first outer electrode, a second outer electrode, and a first via conductor and a second via conductor that pass through a multilayer body in a stacking direction of a plurality of dielectric layers. In the first outer electrode, portions covering a first upper protruding end and a first lower protruding end of the first via conductor define a first upper protruding portion and a first lower protruding portion protruding more than other portions. In the second outer electrode, portions covering a second upper protruding end and a second lower protruding end of the second via conductor define a second upper protruding portion and a second lower protruding portion protruding more than other portions.

### CROSS REFERENCE TO RELATED APPLICATIONS

This application claims the benefit of priority to Japanese Patent Application No. 2024-019143 filed on Feb. 13, 2024 and is a Continuation Application of PCT Application No. PCT/JP2024/044426 filed on Dec. 16, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices such as cellular phones and portable music players have become smaller and thinner. Consequently, multilayer ceramic electronic components to be mounted in such smaller and thinner electronic devices have also become smaller and thinner.

As an example of such multilayer ceramic electronic components, a multilayer ceramic capacitor includes, as described in Japanese Unexamined Patent Application Publication No. 2014-183186, a dielectric chip and outer electrodes formed so as to cover respective end portions of the dielectric chip in the length direction, wherein the dielectric chip is obtained by alternately stacking dielectric ceramic, such as barium titanate, and inner electrodes (see Japanese Unexamined Patent Application Publication No. 2014-183186). The multilayer ceramic capacitor disclosed in Japanese Unexamined Patent Application Publication No. 2014-183186 is, for example, a low-profile multilayer ceramic capacitor having a dimension in the height direction of 150 μm or less. When mounting such a multilayer ceramic capacitor onto a substrate, the multilayer ceramic capacitor is mounted onto the substrate using a mounter.

### SUMMARY OF THE INVENTION

However, when mounting a low-profile multilayer ceramic capacitor onto a mounting substrate using mounter nozzles, there is a possibility that cracks may occur in a multilayer body of the multilayer ceramic capacitor due to the impact during the mounting process, thereby causing insulation failure and the like.

Therefore, example embodiments of the present invention provide multilayer ceramic capacitors each capable of reducing or preventing stress concentration on the multilayer body during the mounting process and reducing or preventing the occurrence of cracks in the multilayer body.

A multilayer ceramic capacitor according to the present invention includes a multilayer body that includes a plurality of stacked dielectric layers, a first main surface and a second main surface facing each other in a stacking direction of the plurality of dielectric layers, a first side surface and a second side surface facing each other in a width direction orthogonal to the stacking direction, a first end surface and a second end surface facing each other in a length direction orthogonal to both the stacking direction and the width direction, a first inner electrode layer alternately stacked with the plurality of dielectric layers, and a second inner electrode layer alternately stacked with the plurality of dielectric layers, a first outer electrode covering at least a portion of each of the first main surface and the second main surface of the multilayer body, a second outer electrode covering at least a portion of each of the first main surface and the second main surface of the multilayer body, a first via conductor passing through the multilayer body in the stacking direction of the plurality of dielectric layers and connected to the first inner electrode layer, and a second via conductor passing through the multilayer body in the stacking direction of the plurality of dielectric layers and connected to the second inner electrode layer. The first via conductor includes a first upper protruding end protruding from the first main surface and a first lower protruding end protruding from the second main surface. The second via conductor includes a second upper protruding end protruding from the first main surface and a second lower protruding end protruding from the second main surface. The first outer electrode covers the first upper protruding end and the first lower protruding end of the first via conductor. The second outer electrode covers the second upper protruding end and the second lower protruding end of the second via conductor. In the first outer electrode, a portion covering the first upper protruding end of the first via conductor includes a first upper protruding portion protruding more than other portions covering the first main surface, and a portion covering the first lower protruding end of the first via conductor includes a first lower protruding portion protruding more than other portions covering the second main surface. In the second outer electrode, a portion covering the second upper protruding end of the second via conductor includes a second upper protruding portion protruding more than other portions covering the first main surface, and a portion covering the second lower protruding end of the second via conductor includes a second lower protruding portion protruding more than other portions covering the second main surface.

According to example embodiments of the present invention, it is possible to provide multilayer ceramic capacitors each capable of reducing or preventing stress concentration on the multilayer body during the mounting process and reducing or preventing the occurrence of cracks in the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a multilayer ceramic capacitor according to an example embodiment of the present invention.

FIG. 2 is a front view showing an example of a multilayer ceramic capacitor according to an example embodiment of the present invention.

FIG. 3 is a plan view showing an example of a multilayer ceramic capacitor according to an example embodiment of the present invention.

FIG. 4 is a schematic cross-sectional view taken along line IV-IV in FIG. 1.

FIG. 5 is a schematic cross-sectional view taken along line V-V in FIG. 4.

FIG. 6 is a schematic cross-sectional view taken along line VI-VI in FIG. 1.

FIG. 7 is a view showing a state in which a multilayer ceramic capacitor according to an example embodiment of the present invention is mounted on a mounting substrate.

FIG. 8 is a schematic cross-sectional view showing a multilayer ceramic capacitor according to a first modification of an example embodiment of the present invention.

FIG. 9 is a view showing a state in which the multilayer ceramic capacitor according to the first modification of an example embodiment of the present invention is mounted on a mounting substrate.

FIG. 10 is a schematic cross-sectional view showing a multilayer ceramic capacitor according to a second modification of an example embodiment of the present invention.

FIG. 11 is a schematic cross-sectional view showing a multilayer ceramic capacitor according to a third modification of an example embodiment of the present invention.

FIGS. 12A to 12E are views for explaining steps of manufacturing a multilayer chip of an example of a multilayer ceramic capacitor according to an example embodiment of the present invention.

FIG. 13 is an external perspective view showing an example of a multilayer ceramic capacitor according to another example embodiment of the present invention.

FIG. 14 is a schematic cross-sectional view taken along line XIV-XIV in FIG. 13.

### DETAILED DESCRIPTION OF THE EXAMPLE EMBODIMENTS

Hereinafter, examples of multilayer ceramic capacitors according to example embodiments of the present invention will be described.

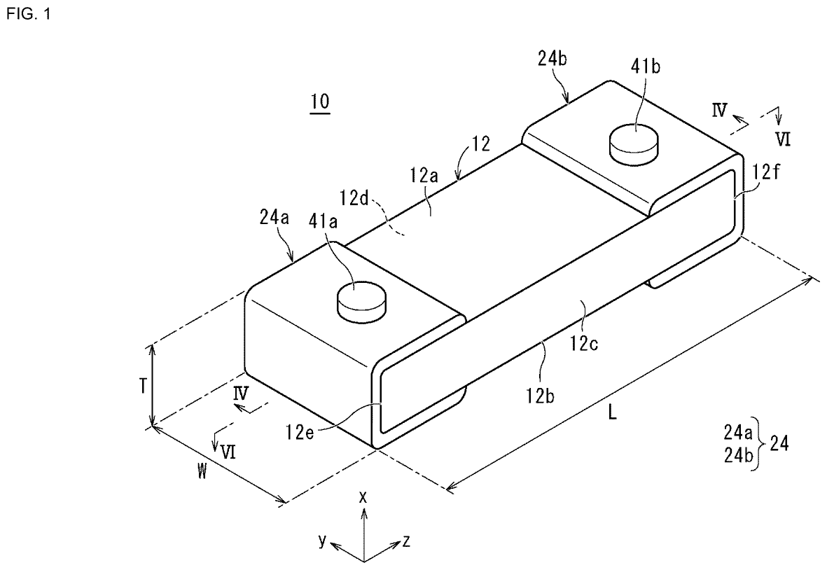

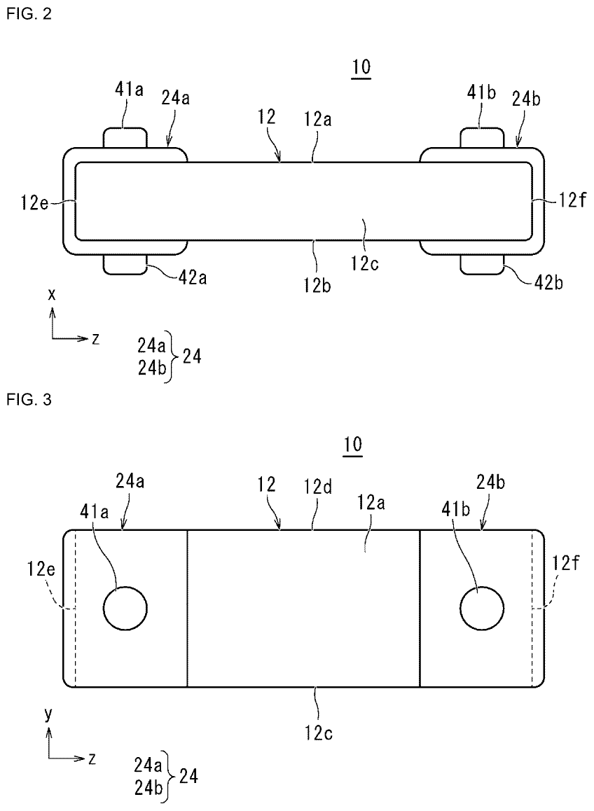

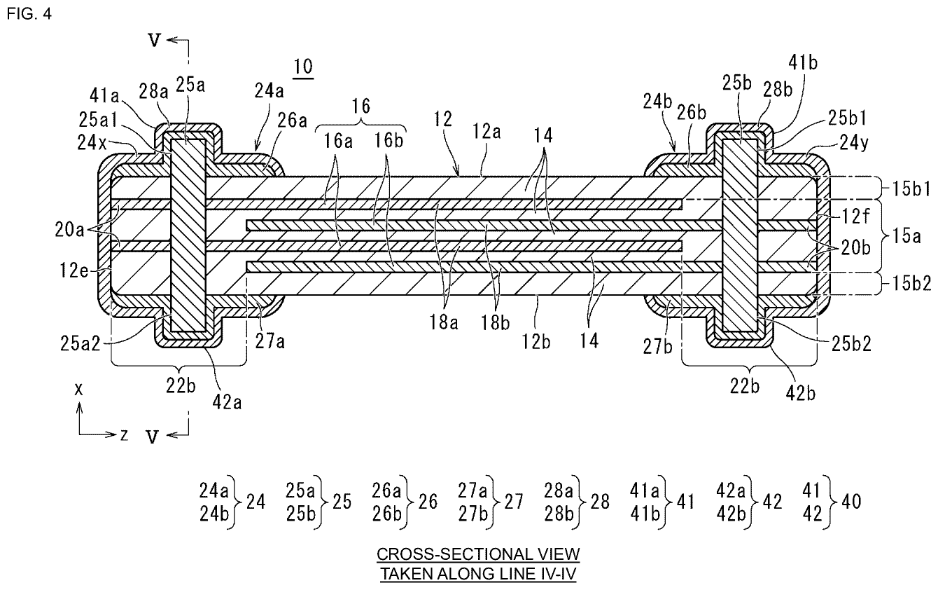

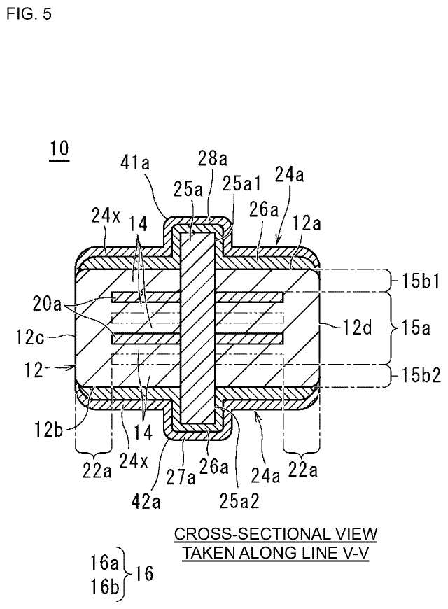

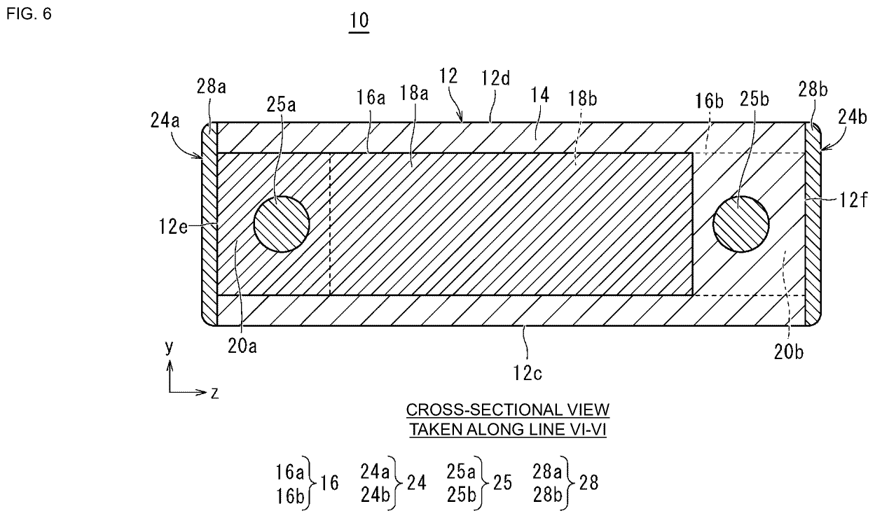

A multilayer ceramic capacitor 10 according to an example embodiment of the present invention will be described. FIG. 1 is an external perspective view showing an example of a multilayer ceramic capacitor according to an example embodiment of the present invention. FIG. 2 is a front view showing an example of a multilayer ceramic capacitor according to an example embodiment of the present invention. FIG. 3 is a plan view showing an example of a multilayer ceramic capacitor according to an example embodiment of the present invention. FIG. 4 is a schematic cross-sectional view taken along line IV-IV in FIG. 1. FIG. 5 is a schematic cross-sectional view taken along line V-V in FIG. 4. FIG. 6 is a schematic cross-sectional view taken along line VI-VI in FIG. 1.

The multilayer ceramic capacitor 10 includes a multilayer body 12 and outer electrodes 24. Hereinafter, the multilayer body 12 and the outer electrodes 24 will be described in this order.

The multilayer body 12 includes a plurality of stacked dielectric layers 14 and a plurality of inner electrode layers 16. Further, the multilayer body 12 includes a first main surface 12a and a second main surface 12b facing each other in a height direction x, which is a stacking direction of the plurality of dielectric layers 14, a first side surface 12c and a second side surface 12d facing each other in a width direction y orthogonal to the height direction x, and a first end surface 12e and a second end surface 12f facing each other in a length direction z orthogonal to both the height direction x and the width direction y. The multilayer body 12 is rounded at corners and ridges.

Here, the term “corner” refers to a portion where three adjacent surfaces of the multilayer body 12 intersect, and the term “ridge” refers to a portion where two adjacent surfaces of the multilayer body 12 intersect. Irregularities and the like may be included on a portion or an entirety of the first main surface 12a and the second main surface 12b, the first side surface 12c and the second side surface 12d, and the first end surface 12e and the second end surface 12f.

As shown in FIGS. 4 and 5, the multilayer body 12 includes, in the height direction x connecting the first main surface 12a and the second main surface 12b, an effective layer portion 15a in which the plurality of inner electrode layers 16 face each other, a first outer layer portion 15b1 including a plurality of dielectric layers 14 located between an inner electrode layer 16 closest to the first main surface 12a side and the first main surface 12a, and a second outer layer portion 15b2 including a plurality of dielectric layers 14 located between an inner electrode layer 16 closest to the second main surface 12b side and the second main surface 12b.

The first outer layer portion 15b1 is located on the first main surface 12a side of the multilayer body 12, and is an aggregate of the plurality of dielectric layers 14 located between the first main surface 12a and the inner electrode layer 16 closest to the first main surface 12a.

The second outer layer portion 15b2 is located on the second main surface 12b side of the multilayer body 12, and is an aggregate of the plurality of dielectric layers 14 located between the second main surface 12b and the inner electrode layer 16 closest to the second main surface 12b.

A region sandwiched between the first outer layer portion 15b1 and the second outer layer portion 15b2 is the effective layer portion 15a.

The number of the stacked dielectric layers 14 is not particularly limited, but preferably is 3 or more and 700 or less including the first outer layer portion 15b1 and the second outer layer portion 15b2, for example. The thickness of each dielectric layer 14 is preferably about 0.4 μm or more and about 2.0 μm or less, for example.

The dielectric layers 14 may be formed of, for example, a dielectric material. A dielectric ceramic including, for example, BaTiO₃, CaTiO₃, SrTiO₃, CaZrO₃, or the like, as a main component, may be used as the dielectric material. Alternatively, a dielectric ceramic added with sub-components, in addition to the main component, in smaller amounts than the main component, may be used as the dielectric material depending on the desired characteristics of the multilayer body, wherein examples of the sub-components include Mn compounds, Fe compounds, Cr compounds, Co compounds, and Ni compounds.

As shown in FIGS. 4 and 5, the inner electrode layers 16 include first inner electrode layers 16a and second inner electrode layers 16b. The first inner electrode layers 16a and the second inner electrode layers 16b are alternately stacked with the dielectric layers 14 interposed therebetween.

Each first inner electrode layer 16a is disposed on the surface of a dielectric layer 14. The first inner electrode layers 16a each include a first facing electrode portion 18a facing the second inner electrode layer 16b, and a first lead-out electrode portion 20a located on one end side of the first inner electrode layer 16a and extending from the first facing electrode portion 18a to the first end surface 12e of the multilayer body 12. An end portion of the first lead-out electrode portion 20a is led out to and exposed at the first end surface 12e.

The shape of the first facing electrode portion 18a of the first inner electrode layer 16a is not particularly limited, but is preferably rectangular in plan view. However, the first facing electrode portion 18a of the first inner electrode layer 16a may have rounded corners in plan view or may have corners formed obliquely (i.e., formed in a tapered shape) in plan view. Further, the first facing electrode portion 18a of the first inner electrode layer 16a may have a tapered shape in plan view so as to be inclined toward one side.

The shape of the first lead-out electrode portion 20a of the first inner electrode layer 16a is not particularly limited, but is preferably rectangular in plan view. However, the first lead-out electrode portion 20a of the first inner electrode layer 16a may have rounded corners in plan view or may have corners formed obliquely (i.e., formed in a tapered shape) in plan view. Further, the first lead-out electrode portion 20a of the first inner electrode layer 16a may have a tapered shape in plan view so as to be inclined toward one side.

The width of the first facing electrode portion 18a of the first inner electrode layer 16a and the width of the first lead-out electrode portion 20a of the first inner electrode layer 16a may be the same, or either one may be formed to be narrower than the other.

Each second inner electrode layer 16b is disposed on the surface of a dielectric layer 14 different from the dielectric layer 14 on which the first inner electrode layer 16a is disposed. The second inner electrode layers 16b each include a second facing electrode portion 18b facing the first inner electrode layer 16a, and a second lead-out electrode portion 20b located on one end side of the second inner electrode layer 16b and extending from the second facing electrode portion 18b to the second end surface 12f of the multilayer body 12. An end portion of the second lead-out electrode portion 20b is led out to and exposed at the second end surface 12f.

The shape of the second facing electrode portion 18b of the second inner electrode layer 16b is not particularly limited, but is preferably rectangular in plan view. However, the second facing electrode portion 18b of the second inner electrode layer 16b may have rounded corners in plan view or may have corners formed obliquely (i.e., formed in a tapered shape) in plan view. Further, the second facing electrode portion 18b of the second inner electrode layer 16b may have a tapered shape in plan view so as to be inclined toward one side.

The shape of the second lead-out electrode portion 20b of the second inner electrode layer 16b is not particularly limited, but is preferably rectangular in plan view. However, the second lead-out electrode portion 20b of the second inner electrode layer 16b may have rounded corners in plan view or may have corners formed obliquely (i.e., formed in a tapered shape) in plan view. Further, the second lead-out electrode portion 20b of the second inner electrode layer 16b may have a tapered shape in plan view so as to be inclined toward one side.

The width of the second facing electrode portion 18b of the second inner electrode layer 16b and the width of the second lead-out electrode portion 20b of the second inner electrode layer 16b may be the same, or either one may be formed to be narrower than the other.

As shown in FIG. 4, the multilayer body 12 includes end portions (hereinafter referred to as “L-gaps”) 22b of the multilayer body 12 formed between an end portion of the first inner electrode layers 16a on the side opposite to the first lead-out electrode portions 20a and the second end surface 12f, and between an end portion of the second inner electrode layers 16b on the side opposite to the second lead-out electrode portions 20b and the first end surface 12e. As shown in FIG. 5, the multilayer body 12 includes side portions (hereinafter referred to as “W-gaps”) 22a of the multilayer body 12 formed between one end of the first facing electrode portions 18a and the second facing electrode portions 18b in the width direction y and the first side surface 12c, and between the other end of the first facing electrode portions 18a and the second facing electrode portions 18b in the width direction y and the second side surface 12d.

The first inner electrode layers 16a and the second inner electrode layers 16b may each be formed of a suitable conductive material including, for example, at least one selected from metals such as Ni, Cu, Ag, Pd, and Au, and alloys such as Ag—Pd alloys, with Ni as a main component. The inner electrode layers 16 may further include dielectric particles of the same composition as the ceramics included in the dielectric layers 14.

Further, the first inner electrode layers 16a and the second inner electrode layers 16b may include Sn. By including Sn in the first inner electrode layers 16a and the second inner electrode layers 16b, electric field concentration at interfaces between the first inner electrode layers 16a and the second inner electrode layers 16b and the dielectric layers 14 can be alleviated, thereby improving high-temperature load reliability. In such a case, sufficient effects can be achieved even if Sn is included only in one of the first inner electrode layers 16a and the second inner electrode layers 16b.

In the present example embodiment, electrostatic capacitance is generated by the first facing electrode portions 18a of the first inner electrode layers 16a and the second facing electrode portions 18b of the second inner electrode layers 16b facing each other with the dielectric layers 14 interposed therebetween, thus exhibiting capacitor characteristics.

The number of the stacked inner electrode layers 16 is not particularly limited, but preferably is 2 or more and 700 or less, for example. The thickness of each inner electrode layer 16 is preferably about 0.2 μm or more and about 2.0 μm or less, for example.

Via conductors 25 are disposed on a side near the first end surface 12e and a side near the second end surface 12f of the multilayer body 12, as shown in FIGS. 4 to 6.

The via conductors 25 include a first via conductor 25a and a second via conductor 25b.

The first via conductor 25a passes through a portion of the multilayer body 12 on the side near the first end surface 12e in the height direction x, with one end thereof, as a first upper protruding end 25a1, protruding from the first main surface 12a, and the other end thereof, as a first lower protruding end 25a2, protruding from the second main surface 12b.

Within the multilayer body 12, the first via conductor 25a passes through an end portion 22b that includes only the first lead-out electrode portions 20a of the first inner electrode layers 16a, when viewed in the height direction x. In such a case, the first via conductor 25a is electrically connected to the first lead-out electrode portions 20a of the first inner electrode layers 16a.

The end-surface shape of the first via conductor 25a is preferably circular when viewed in the height direction x. However, the end-surface shape of the first via conductor 25a may alternatively be elliptical, oblong, or any other shape. When the end-surface shape of the first via conductor 25a is circular, the diameter thereof is preferably at least in a range of about 6 μm or more and about 100 μm or less, for example. When the end-surface shape of the first via conductor 25a is elliptical, the minor axis thereof is preferably in a range of about 6 μm or more and about 100 μm or less, for example.

The amount by which the first upper protruding end 25a1 of the first via conductor 25a protrudes from the first main surface 12a is preferably about 5 μm or more and about 20 μm or less, for example. The amount by which the first lower protruding end 25a2 of the first via conductor 25a protrudes from the second main surface 12b is preferably about 5 μm or more and about 20 μm or less, for example.

The second via conductor 25b passes through a portion of the multilayer body 12 on the side near the second end surface 12f in the height direction x, with one end thereof, as a second upper protruding end 25b1, protruding from the first main surface 12a, and the other end thereof, as a second lower protruding end 25b2, protruding from the second main surface 12b.

Within the multilayer body 12, the second via conductor 25b passes through an end portion 22b that includes only the second lead-out electrode portions 20b of the second inner electrode layers 16b, when viewed in the height direction x. In such a case, the second via conductor 25b is electrically connected to the second lead-out electrode portions 20b of the second inner electrode layers 16b.

The end-surface shape of the second via conductor 25b is preferably circular when viewed in the height direction x. However, the end-surface shape of the second via conductor 25b may alternatively be elliptical, oblong, or any other shape. When the end-surface shape of the second via conductor 25b is circular, the diameter thereof is preferably at least in a range of about 6 μm or more and about 100 μm or less, for example. When the end-surface shape of the second via conductor 25b is elliptical, the minor axis thereof is preferably in a range of about 6 μm or more and about 100 μm or less, for example.

The amount by which the second upper protruding end 25b1 of the second via conductor 25b protrudes from the first main surface 12a is preferably about 5 μm or more and about 20 μm or less, for example. The amount by which the second lower protruding end 25b2 of the second via conductor 25b protrudes from the second main surface 12b is preferably about 5 μm or more and about 20 μm or less, for example.

The via conductors 25 may be formed of, for example, a conductive paste including conductive metal powder having Ag, Cu, or Ni as a main component.

The outer electrodes 24 are disposed on the first end surface 12e side and the second end surface 12f side of the multilayer body 12, as shown in FIGS. 1 to 6.

The outer electrodes 24 include a base electrode layer and a plating layer 28, wherein the base electrode layer includes an upper base electrode layer 26 formed so as to cover the first main surface 12a side of the multilayer body 12 and a lower base electrode layer 27 formed so as to cover the second main surface 12b side of the multilayer body 12, and the plating layer 28 covers the upper base electrode layer 26 and the lower base electrode layer 27.

The outer electrodes 24 include a first outer electrode 24a and a second outer electrode 24b.

The first outer electrode 24a is disposed on the first end surface 12e of the multilayer body 12 and also on a portion of the first main surface 12a and a portion of the second main surface 12b. In such a case, the first outer electrode 24a is electrically connected to the first lead-out electrode portions 20a of the first inner electrode layers 16a. The first outer electrode 24a may extend slightly onto a portion of the first side surface 12c and a portion of the second side surface 12d.

The first outer electrode 24a covers the first upper protruding end 25a1 of the first via conductor 25a protruding from the first main surface 12a of the multilayer body 12. In the first outer electrode 24a, a portion covering the first upper protruding end 25a1 includes a first upper protruding portion 41a protruding more than other portions covering the first main surface 12a. Thus, the first outer electrode 24a protrudes from a surface 24x in accordance with the shape of the first upper protruding end 25a1.

The first outer electrode 24a covers the first lower protruding end 25a2 of the first via conductor 25a protruding from the second main surface 12b of the multilayer body 12. In the first outer electrode 24a, a portion covering the first lower protruding end 25a2 includes a first lower protruding portion 42a protruding more than other portions covering the second main surface 12b. Thus, the first outer electrode 24a protrudes from the surface 24x in accordance with the shape of the first lower protruding end 25a2.

The second outer electrode 24b is disposed on the second end surface 12f of the multilayer body 12 and also on a portion of the first main surface 12a and a portion of the second main surface 12b. In such a case, the second outer electrode 24b is electrically connected to the second lead-out electrode portions 20b of the second inner electrode layers 16b. The second outer electrode 24b may extend slightly onto a portion of the first side surface 12c and a portion of the second side surface 12d.

The second outer electrode 24b covers the second upper protruding end 25b1 of the second via conductor 25b protruding from the first main surface 12a of the multilayer body 12. In the second outer electrode 24b, a portion covering the second upper protruding end 25b1 includes a second upper protruding portion 41b protruding more than other portions covering the first main surface 12a. Thus, the second outer electrode 24b protrudes from a surface 24y in accordance with the shape of the second upper protruding end 25b1.

The second outer electrode 24b covers the second lower protruding end 25b2 of the second via conductor 25b protruding from the second main surface 12b of the multilayer body 12. In the second outer electrode 24b, a portion covering the second lower protruding end 25b2 includes a second lower protruding portion 42b protruding more than other portions covering the second main surface 12b. Thus, the second outer electrode 24b protrudes from the surface 24y in accordance with the shape of the second lower protruding end 25b2.

The first upper protruding portion 41a, the first lower protruding portion 42a, the second upper protruding portion 41b, and the second lower protruding portion 42b each preferably have a dimension of about 5 μm or more from each of the surfaces 24x and 24y in the height direction x, for example. Further, in such a case, it is preferable that a height of the first upper protruding portion 41a specified by the protruding amount of the first upper protruding end 25a1 of the first via conductor 25a and the thickness of the first outer electrode 24a be equal to a height of the second upper protruding portion 41b specified by the protruding amount of the second upper protruding end 25b1 of the second via conductor 25b and the thickness of the second outer electrode 24b. Similarly, it is preferable that a height of the first lower protruding portion 42a specified by the protruding amount of the first lower protruding end 25a2 of the first via conductor 25a and the thickness of the first outer electrode 24a be equal to a height of the second lower protruding portion 42b specified by the protruding amount of the second lower protruding end 25b2 of the second via conductor 25b and the thickness of the second outer electrode 24b.

The upper base electrode layer 26 of the base electrode layer includes a first upper base electrode layer 26a and a second upper base electrode layer 26b.

The lower base electrode layer 27 of the base electrode layer includes a first lower base electrode layer 27a and a second lower base electrode layer 27b.

The first upper base electrode layer 26a covers a portion of the first main surface 12a on the first end surface 12e side of the multilayer body 12 and the first upper protruding end 25a1 of the first via conductor 25a, and not to cover the first end surface 12e of the multilayer body 12. Alternatively, the first upper base electrode layer 26a may not cover a portion of the first via conductor 25a.

The first lower base electrode layer 27a covers a portion of the second main surface 12b on the first end surface 12e side of the multilayer body 12 and the first lower protruding end 25a2 of the first via conductor 25a, and not to cover the first end surface 12e of the multilayer body 12. Alternatively, the first lower base electrode layer 27a may not cover a portion of the first via conductor 25a.

The second upper base electrode layer 26b covers a portion of the first main surface 12a on the second end surface 12f side of the multilayer body 12 and the second upper protruding end 25b1 of the second via conductor 25b, and not to cover the second end surface 12f of the multilayer body 12. Alternatively, the second upper base electrode layer 26b may not cover a portion of the second via conductor 25b.

The second lower base electrode layer 27b covers a portion of the second main surface 12b on the second end surface 12f side of the multilayer body 12 and the second lower protruding end 25b2 of the second via conductor 25b, and not to cover the second end surface 12f of the multilayer body 12. Alternatively, the second lower base electrode layer 27b may not cover a portion of the second via conductor 25b.

The upper base electrode layer 26 and the lower base electrode layer 27 formed as thin film layers are preferably formed by a thin film formation method such as sputtering or vapor deposition. In particular, the upper base electrode layer 26 and the lower base electrode layer 27 formed as thin film layers are preferably sputtered electrodes formed by sputtering. Hereinafter, electrodes formed by sputtering will be described.

When forming the upper base electrode layer 26 and the lower base electrode layer 27 as sputtered electrodes, it is preferable to directly form the sputtered electrodes on portions of the second main surface 12b of the multilayer body 12.

The upper base electrode layer 26 and the lower base electrode layer 27 may include, for example, a metal such as Ni, Cu, Ag, Pd, an Ag—Pd alloy, or Au. In such a case, it is preferable that the upper base electrode layer 26 and the lower base electrode layer 27 include, as a co-material, the same dielectric material as the dielectric ceramic included in the dielectric layers 14. By including the co-material, the shrinkage behavior of the upper base electrode layer 26 and the lower base electrode layer 27 during firing can be made closer to the shrinkage behavior of the multilayer body 12, thus preventing the upper base electrode layer 26 and the lower base electrode layer 27 from peeling from the multilayer body 12.

The plating layer 28 includes a first plating layer 28a and a second plating layer 28b.

The first plating layer 28a integrally covers the first upper base electrode layer 26a, the first lower base electrode layer 27a, and the first end surface 12e of the multilayer body 12.

The second plating layer 28b integrally covers the second upper base electrode layer 26b, the second lower base electrode layer 27b, and the second end surface 12f of the multilayer body 12.

The plating layer 28 may include a single layer or may include a plurality of layers.

The plating layer 28 is not particularly limited as long as it includes, as a main metal component, at least one of, for example, Cu, Ni, Ag, Pd, an Ag—Pd alloy, or Au.

When the plating layer 28 includes a single layer, in a case where, for example, the first inner electrode layers 16a and the second inner electrode layers 16b are formed using Ni, it is preferable that the plating layer 28 is formed by performing Cu plating that includes good bondability with Ni.

When the plating layer 28 includes a plurality of layers, it is preferable that a lower layer directly bonded to the first inner electrode layers 16a and the second inner electrode layers 16b is formed by performing Cu plating as described above, and that an upper layer disposed on the lower layer is a Ni plating layer to prevent erosion by solder. When the plating layer 28 includes a three-layer structure, it is preferable that the structure be, for example, Cu plating, Ni plating, Sn plating in order from the multilayer body 12 side, or be Cu plating, Ni plating, Cu plating in order from the multilayer body 12 side. However, the structure is not limited to such combinations.

When the plating layer 28 includes a plurality of layers, the thickness of each layer is preferably about 0.5 μm or more and about 10.0 μm or less, for example.

The dimension of the multilayer ceramic capacitor 10 that includes the multilayer body 12, the first outer electrode 24a, and the second outer electrode 24b, in the length direction z, is defined as an L-dimension, the dimension of the multilayer ceramic capacitor 10 that includes the multilayer body 12, the first outer electrode 24a, and the second outer electrode 24b, in the height direction x, is defined as a T-dimension, and the dimension of the multilayer ceramic capacitor 10 that includes the multilayer body 12, the first outer electrode 24a, and the second outer electrode 24b, in the width direction y, is defined as a W-dimension.

The dimensions of the multilayer ceramic capacitor 10 are preferably such that the L-dimension in the length direction z is about 0.2 mm or more and about 3.2 mm or less, the W-dimension in the width direction y is about 0.1 mm or more and about 2.5 mm or less, and the T-dimension in the height direction x is about 0.04 mm or more and about 0.30 mm or less, for example.

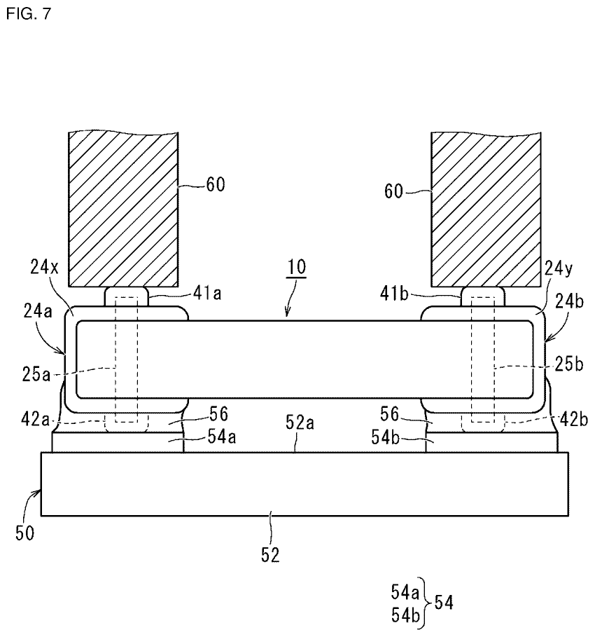

A state in which the multilayer ceramic capacitor 10 is mounted on a mounting substrate 50 using mounter nozzles 60 will be described. FIG. 7 is a view showing a state in which the multilayer ceramic capacitor according to the present example embodiment of the present invention is mounted on a mounting substrate.

As shown in FIG. 7, the multilayer ceramic capacitor 10 according to the present example embodiment of the present invention is sucked by using the mounter nozzles 60 and mounted on the mounting substrate 50. The mounting substrate 50 includes a core material 52 of the substrate and conductor lands 54. The core material 52 of the substrate is formed of, for example, a substrate made of a material obtained by impregnating a base material in which glass cloth and glass nonwoven fabric are mixed with epoxy resin or polyimide resin, or a ceramic substrate manufactured by firing a sheet in which ceramics and glass are mixed. The core material 52 of the substrate may be a single-layer substrate or may be a multilayer substrate formed by stacking a plurality of layers.

One main surface of the core material 52 of the substrate defines a substrate-side mounting surface 52a on which the conductor lands 54 are disposed and which serves as a mounting surface of the multilayer ceramic capacitor 10.

The conductor lands 54 include a first conductor land 54a and a second conductor land 54b. The first conductor land 54a is a portion that is electrically connected and mechanically bonded to the first outer electrode 24a of the multilayer ceramic capacitor 10 by a bonding material 56. The second conductor land 54b is a portion that is electrically connected and mechanically bonded to the second outer electrode 24b of the multilayer ceramic capacitor 10 by the bonding material 56.

The material of the conductor lands 54 is not particularly limited. For example, metals such as copper, gold, palladium, and platinum may be used as the material of the conductor lands 54. The thickness of the conductor lands 54, i.e., the dimension of the conductor lands 54 in the height direction x, is not particularly limited, but is preferably, for example, about 20 μm or more and about 200 μm or less. The bonding material 56 may be, for example, solder.

The multilayer ceramic capacitor 10 is mounted on the mounting substrate 50 such that the second main surface 12b thereof faces the substrate-side mounting surface 52a. At this time, the first lower protruding portion 42a and the second lower protruding portion 42b of the multilayer ceramic capacitor 10 are bonded to the mounting substrate 50.

On the other hand, when the multilayer ceramic capacitor 10 is sucked by the mounter nozzles 60 during the mounting process, the first upper protruding portion 41a and the second upper protruding portion 41b of the multilayer ceramic capacitor 10 come into contact with the mounter nozzles 60.

The multilayer ceramic capacitor 10 comes into contact with the mounter nozzles 60 when the first lower protruding portion 42a and the second lower protruding portion 42b come into contact with the mounting substrate 50 (conductor lands 54). Thus, during the mounting process, stress concentration applied to end portions of the outer electrode 24 disposed on the second main surface 12b side of the multilayer ceramic capacitor 10 can be alleviated.

Therefore, it becomes possible to reduce or prevent cracks during the mounting process even when the multilayer ceramic capacitor is reduced in thickness, particularly even when the multilayer body 12 is reduced in thickness.

Note that the multilayer ceramic capacitor 10 may alternatively have a configuration in which the first lead-out electrode portions 20a of the first inner electrode layers 16a and the second lead-out electrode portions 20b of the second inner electrode layers 16b are not exposed at each of the first end surface 12e and the second end surface 12f of the multilayer body 12. Even in such a case, electrical connections between each of the first outer electrode 24a and the second outer electrode 24b and the first inner electrode layers 16a and the second inner electrode layers 16b are maintained via the first via conductor 25a and the second via conductor 25b.

Thus, when the multilayer ceramic capacitor 10 is mounted, adhesion strength to the substrate can be improved. Further, the mounted state of the multilayer ceramic capacitor 10 can be easily determined by visual inspection. Further, the first plating layer 28a and the second plating layer 28b located at the first end surface 12e and the second end surface 12f, respectively, may be omitted or thinned, thus reducing the thickness of the plating layer 28.

Next, modifications of the multilayer ceramic capacitors according to the above-described example embodiments will be described. For each modification, components corresponding to those of the above example embodiments are denoted by the same reference signs, and detailed description thereof will be omitted.

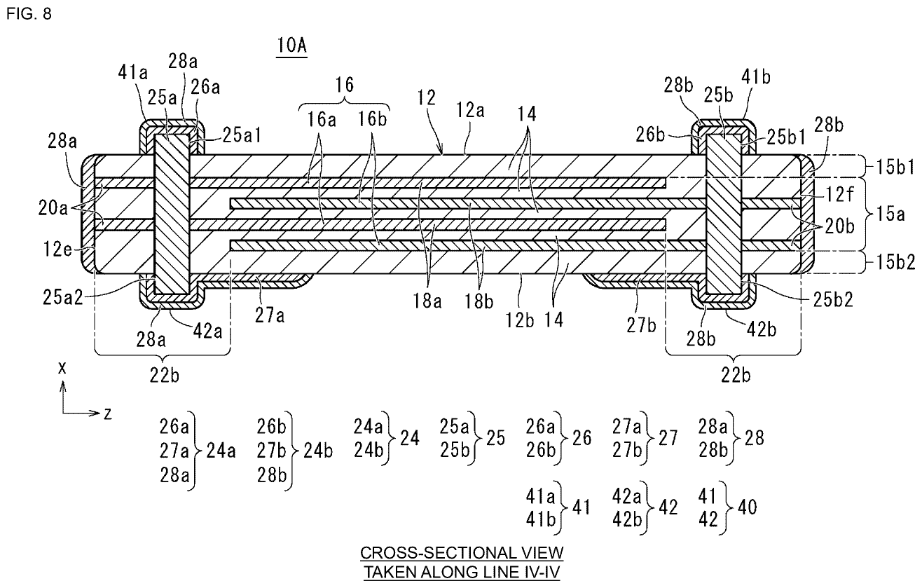

A multilayer ceramic capacitor according to a first modification of an example embodiment of the present invention will be described. FIG. 8 is a schematic cross-sectional view showing a multilayer ceramic capacitor 10A as an example of the multilayer ceramic capacitor according to the first modification of an example embodiment of the present invention.

The multilayer ceramic capacitor 10A according to the first modification includes a configuration in which, in the first outer electrode 24a, a portion covering the first end surface 12e of the multilayer body 12, a portion covering a portion of the first main surface 12a, and a portion covering a portion of the second main surface 12b are spaced apart from each other. Similarly, in the second outer electrode 24b, a portion covering the second end surface 12f of the multilayer body 12, a portion covering a portion of the first main surface 12a, and a portion covering a portion of the second main surface 12b are spaced apart from each other.

A specific feature of the first outer electrode 24a is as follows. That is, the first upper base electrode layer 26a is disposed on the first main surface 12a so as to selectively cover the first upper protruding end 25a1 of the first via conductor 25a. The first lower base electrode layer 27a is disposed on the second main surface 12b so as to selectively cover the first lower protruding end 25a2 of the first via conductor 25a and a portion closer to the center side of the multilayer body 12 from the first lower protruding end 25a2. The first plating layer 28a covers the first end surface 12e.

A specific feature of the second outer electrode 24b is as follows. That is, the second upper base electrode layer 26b is disposed on the first main surface 12a so as to selectively cover the second upper protruding end 25b1 of the second via conductor 25b. The second lower base electrode layer 27b is disposed on the second main surface 12b so as to selectively cover the second lower protruding end 25b2 of the second via conductor 25b and a portion closer to the center side of the multilayer body 12 from the second lower protruding end 25b2. The second plating layer 28b covers the second end surface 12f.

Hereinafter, with respect to the multilayer ceramic capacitor 10A, the first upper base electrode layer 26a and the second upper base electrode layer 26b will be referred to as first main-surface electrodes, and the first lower base electrode layer 27a and the second lower base electrode layer 27b will be referred to as second main-surface electrodes. Further, the first plating layer 28a disposed on the first end surface 12e will be referred to as a first end-surface electrode, and the second plating layer 28b disposed on the second end surface 12f will be referred to as the second end-surface electrode.

Further, in the multilayer ceramic capacitor 10A, the first plating layer 28a covers the first upper base electrode layer 26a and the first lower base electrode layer 27a. The second plating layer 28b covers the second upper base electrode layer 26b and the second lower base electrode layer 27b.

With the above configuration, the multilayer ceramic capacitor 10A according to the first modification can reduce the thickness of the outer electrode 24 in the stacking direction, thereby providing a further-thinned multilayer ceramic capacitor while suppressing the occurrence of cracks during the mounting process.

Further, the multilayer ceramic capacitor 10A according to the first modification achieves the following effects by disposing the second main-surface electrodes so as to cover, on the second main surface 12b of the multilayer body 12, a portion closer to the center side of the multilayer body 12. That is, when mounting the multilayer ceramic capacitor 10 as shown in FIG. 7, an impact applied from the mounter nozzles 60 to the multilayer ceramic capacitor 10 is transmitted mainly from each of the first upper protruding portion 41a and the second upper protruding portion 41b to the first lower protruding portion 42a and the second lower protruding portion 42b via each of the first via conductor 25a and the second via conductor 25b.

At this time, in the multilayer ceramic capacitor 10A according to the first modification, the second main-surface electrodes absorb stress transmitted to the first lower protruding portion 42a and the second lower protruding portion 42b, thus further reducing direct transmission of stress from the mounter nozzles 60 to the multilayer body 12 and mitigating damage to the multilayer body 12.

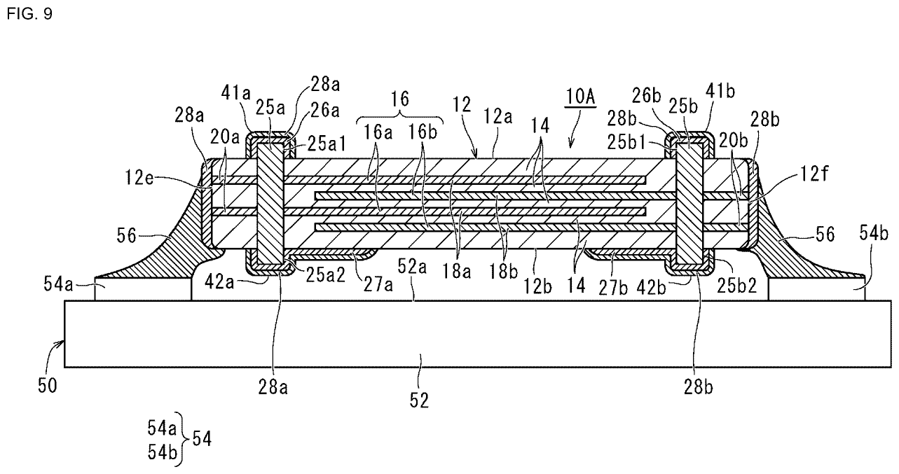

Further, as shown in FIG. 9, the multilayer ceramic capacitor 10A according to the first modification is mounted on the mounting substrate 50 by connecting, via the bonding material 56, the first end-surface electrode and the second end-surface electrode with respect to the first conductor land 54a and the second conductor land 54b disposed on the mounting substrate 50. Thus, it becomes unnecessary to use the first main-surface electrodes and the second main-surface electrodes in the mounting process, so that the mounting area on the multilayer ceramic capacitor 10A can be reduced.

Further, since the first plating layer 28a covers the first upper base electrode layer 26a and the first lower base electrode layer 27a, and the second plating layer 28b covers the second upper base electrode layer 26b and the second lower base electrode layer 27b, a larger number of mounting portions can be obtained in the multilayer ceramic capacitor 10A.

Next, a multilayer ceramic capacitor 10B according to a second modification will be described.

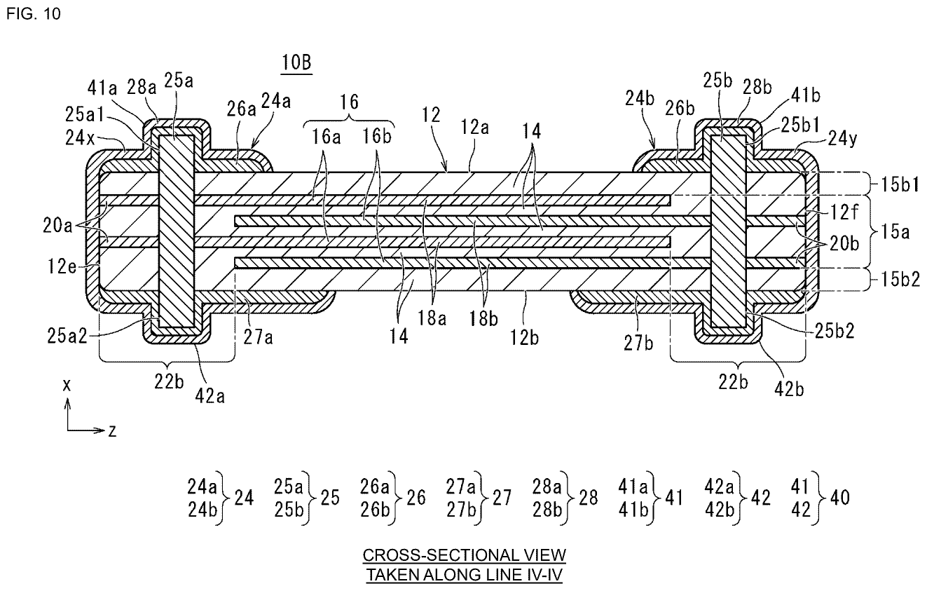

As shown in FIG. 10, the multilayer ceramic capacitor 10B according to the second modification may be implemented in combination with the multilayer ceramic capacitor 10 according to the present example embodiment of the present invention, in the configuration of the outer electrode 24 of the multilayer ceramic capacitor 10A according to the first modification. That is, the outer electrode 24 may include the base electrode layers 26 and 27. Thus, an effect similar to that of the multilayer ceramic capacitor 10A shown in FIG. 8, i.e., further reducing direct transmission of stress from the mounter nozzles 60 to the multilayer body 12 and mitigating damage to the multilayer body 12, can be achieved.

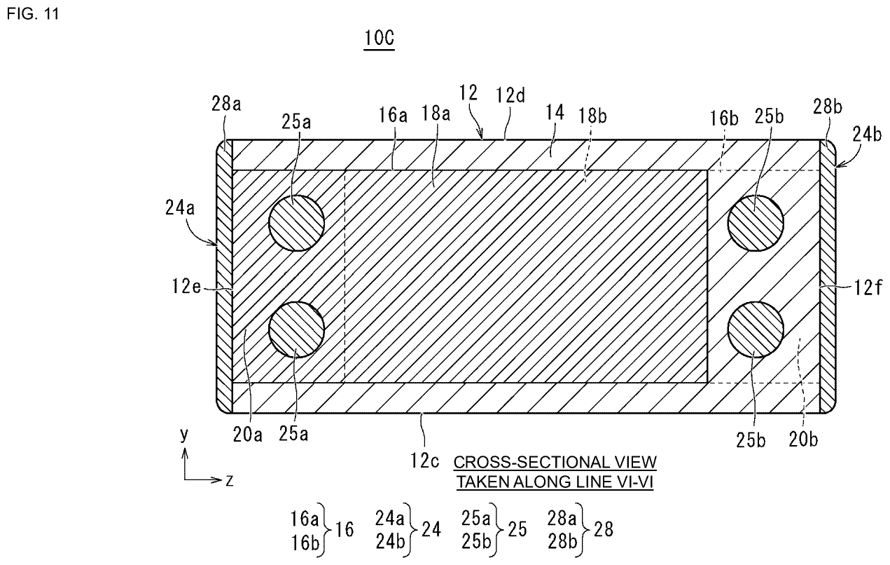

Next, a multilayer ceramic capacitor 10C according to a third modification of an example embodiment of the present invention will be described. FIG. 11 is a schematic cross-sectional view showing the multilayer ceramic capacitor according to the third modification of an example embodiment of the present invention.

In the multilayer ceramic capacitor 10C according to the third modification, the number of via conductors 25 can be changed as appropriate. Specifically, as shown in FIG. 11, two first via conductors 25a each passing through an end portion 22b that includes only the first lead-out electrode portions 20a of the first inner electrode layers 16a are arranged in the width direction y, when viewed in the height direction x. Similarly, two second via conductors 25b each passing through an end portion 22b that includes only the second lead-out electrode portions 20b of the second inner electrode layers 16b are arranged in the width direction y, when viewed in the height direction x.

The number of the via conductors 25 is preferably varied depending on the dimensions of the multilayer ceramic capacitor 10C. Specifically, when the chip size of the multilayer ceramic capacitor 10C is such that the L-dimension in the length direction z is about 0.4 mm or more and the W-dimension in the width direction y is about 0.2 mm or more, for example, it is preferable that the number of each of the first via conductors 25a and the second via conductors 25b be two or more, for example.

Further, the positions of the via conductors 25 in a view in the height direction x preferably correspond to positions of the mounter for mounting the multilayer ceramic capacitor 10C. That is, it is preferable that each of the mounter nozzles 60 shown in FIG. 7 be provided so as to evenly contact each of the first via conductors 25a and the second via conductors 25b of the via conductors 25.

Thus, even when the multilayer ceramic capacitor is reduced in thickness, the multilayer ceramic capacitor can be stably mounted on the mounting substrate in accordance with the dimensions of the multilayer ceramic capacitor, and the occurrence of cracks during the mounting process can be effectively reduced or prevented.

Hereinafter, a non-limiting example of a method for manufacturing a multilayer ceramic capacitor, which is an example of the multilayer ceramic capacitors according to the above example embodiments, will be described.

First, dielectric sheets and a conductive paste for inner electrodes are prepared. The dielectric sheets and the conductive paste for inner electrode layers include a binder (for example, a known organic binder) and an organic solvent (for example, a known organic solvent).

Next, the conductive paste for inner electrodes is printed on the dielectric sheets in a predetermined pattern by, for example, screen printing or gravure printing to form an inner electrode pattern. Note that, as for the dielectric sheets, dielectric sheets for outer layers on which no inner electrode pattern is printed are also prepared.

A predetermined number of dielectric sheets for outer layers on which no inner electrode pattern is formed are stacked, and on such stacked dielectric sheets, dielectric sheets on which an inner electrode pattern corresponding to the first inner electrode layers 16a is formed and dielectric sheets on which an inner electrode pattern corresponding to the second inner electrode layers 16b is formed are alternately stacked, and further, on such stacked dielectric sheets, a predetermined number of dielectric sheets for outer layers on which no inner electrode pattern is formed are stacked, whereby a stacked sheet is produced.

Further, the stacked sheet is pressed in the stacking direction via isostatic pressing to produce a stacked block.

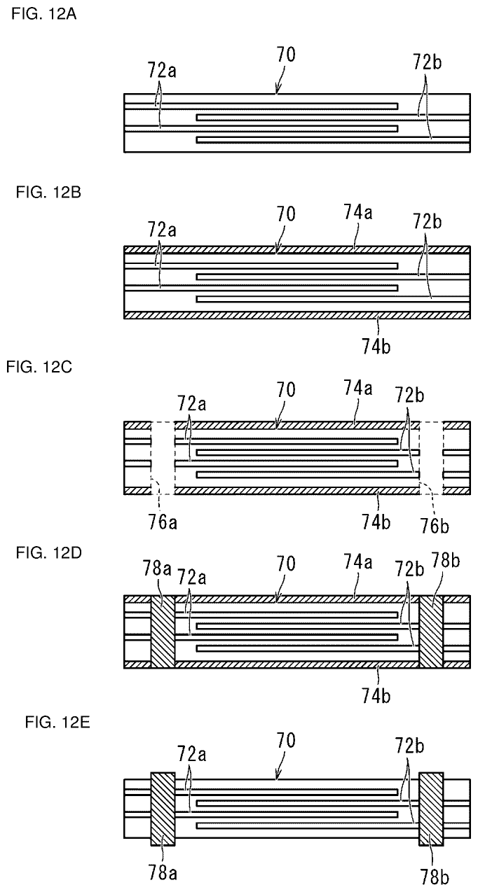

Subsequently, the stacked block is cut into a predetermined size to cut out multilayer chips 70. Thereafter, barreling may be performed to round the corners and the ridges of each multilayer chip 70. Thus, the multilayer chip 70 shown in FIG. 12A is obtained.

Subsequently, as shown in FIG. 12B, a protective film 74a is provided on the entire first main surface side of the obtained multilayer chip 70, and a protective film 74b is provided on the entire second main surface side of the obtained multilayer chip 70. For example, sheets, films, and the like made of polyethylene naphthalate (PEN), polyamide, polyimide, or the like may be used as the material of the protective film 74a and the protective film 74b.

Subsequently, as shown in FIG. 12C, in the multilayer chip provided with the protective film 74a and the protective film 74b, a via hole 76a, which is a through hole, is opened at a predetermined position where only first inner electrode patterns 72a are stacked, and a via hole 76b, which is a through hole, is opened at a predetermined position where only second inner electrode patterns 72b are stacked. For example, a laser such as a CO₂ laser can be used for opening the via hole 76a and the via hole 76b.

Subsequently, as shown in FIG. 12D, in the multilayer chip 70 provided with the protective film 74a and the protective film 74b, the via hole 76a is filled with a via-conductor paste 78a, and the via hole 76b is filled with a via-conductor paste 78b. The via-conductor pastes 78a and 78b are preferably prepared by mixing, for example, in addition to conductive metal powder having Ag, Cu, or Ni as a main component, a predetermined ratio of a co-material in consideration of thermal shrinkage during firing of the multilayer chip in a later step and adhesion to the via hole 76a and the via hole 76b.

The via-conductor pastes 78a and 78b are preferably filled so as to be flush with the surfaces of the protective film 74a and the protective film 74b, respectively.

Subsequently, as shown in FIG. 12E, the protective film 74a and the protective film 74b are removed from the multilayer chip 70 in which the via hole 76a is filled with the via-conductor paste 78a and the via hole 76b is filled with the via-conductor paste 78b. Thus, one end of the via-conductor paste 78a filled in the via hole 76a is exposed on the first main surface side of the multilayer chip 70 in a protruding state, thereby forming the first upper protruding end 25a1 of the first via conductor 25a in the completed product. Further, one end of the via-conductor paste 78b filled in the via hole 76b is exposed on the first main surface side in a protruding state, thereby forming the second upper protruding end 25b1 of the second via conductor 25b in the completed product.

Similarly, the other end of the via-conductor paste 78a filled in the via hole 76a is exposed on the second main surface side in a protruding state, thereby forming the first lower protruding end 25a2 of the first via conductor 25a in the completed product. Further, the other end of the via-conductor paste 78b filled in the via hole 76b is exposed on the second main surface side in a protruding state, thereby forming the second lower protruding end 25b2 of the second via conductor 25b in the completed product.

Next, the multilayer chip 70 is fired to produce the multilayer body 12. The firing temperature depends on materials of the ceramics and the inner electrode layers 16, but preferably is about 900° C. or more and about 1400° C. or less, for example.

Subsequently, the first upper base electrode layer 26a and the second upper base electrode layer 26b of the upper base electrode layer 26 are formed by sputtering on a portion of the first main surface 12a of the multilayer body 12 including one end of the conductive paste corresponding to the first upper protruding end 25a1 and on a portion of the first main surface 12a of the multilayer body 12 including one end of the conductive paste corresponding to the second upper protruding end 25b1. When forming the first upper base electrode layer 26a by sputtering, the first upper base electrode layer 26a may be formed so as not to cover a portion of the first upper protruding end 25a1. When forming the second upper base electrode layer 26b by sputtering, the second upper base electrode layer 26b may be formed so as not to cover a portion of the second upper protruding end 25b1.

Similarly, the first lower base electrode layer 27a and the second lower base electrode layer 27b of the lower base electrode layer 27 are formed by sputtering on a portion of the second main surface 12b of the multilayer body 12 including one end of the conductive paste corresponding to the first lower protruding end 25a2 and on a portion of the second main surface 12b of the multilayer body 12 including one end of the conductive paste corresponding to the second lower protruding end 25b2. When forming the first lower base electrode layer 27a by sputtering, the first lower base electrode layer 27a may be formed so as not to cover a portion of the first lower protruding end 25a2. When forming the second lower base electrode layer 27b by sputtering, the second lower base electrode layer 27b may be formed so as not to cover a portion of the second lower protruding end 25b2.

Subsequently, the first plating layer 28a and the second plating layer 28b of the plating layer 28 are formed on the upper base electrode layer 26 and the lower base electrode layer 27 and on each of the first end surface 12e and the second end surface 12f of the multilayer body 12. The first plating layer 28a is formed so as to continuously cover the first upper base electrode layer 26a, the first end surface 12e, and the first lower base electrode layer 27a, and the second plating layer 28b is formed so as to continuously cover the second upper base electrode layer 26b, the second end surface 12f, and the second lower base electrode layer 27b. Specifically, assuming that the plating layer 28 is formed by performing Cu plating, the plating layer 28 is formed by electrolytic plating or electroless plating.

At this time, heat treatment is performed on the multilayer body 12 after plating to remove residual moisture remaining in the plating film and/or remaining at the interface between the ceramics and the plating.

In manufacturing the multilayer ceramic capacitor 10A according to the first modification shown in FIG. 8, steps after obtaining the multilayer body 12 are as follows. That is, the first upper base electrode layer 26a of the upper base electrode layer 26 and the first lower base electrode layer 27a of the lower base electrode layer 27 are selectively formed on (i) one end of the conductive paste corresponding to the first upper protruding end 25a1, (ii) one end of the conductive paste corresponding to the first lower protruding end 25a2, and (iii) a portion closer to the center side of the multilayer body 12 from the one end of the conductive paste corresponding to the first lower protruding end 25a2. Similarly, the second upper base electrode layer 26b of the upper base electrode layer 26 and the second lower base electrode layer 27b of the lower base electrode layer 27 are selectively formed on (i) one end of the conductive paste corresponding to the second upper protruding end 25b1, (ii) one end of the conductive paste corresponding to the second lower protruding end 25b2, and (iii) a portion closer to the center side of the multilayer body 12 from the one end of the conductive paste corresponding to the second lower protruding end 25b2.

Subsequently, the first plating layer 28a covers the first upper base electrode layer 26a, the first lower base electrode layer 27a, and the first end surface 12e of the multilayer body 12. Similarly, the second plating layer 28b covers the second upper base electrode layer 26b, the second lower base electrode layer 27b, and the second end surface 12f of the multilayer body 12. Thus, the first outer electrode 24a and the second outer electrode 24b are obtained.

As described above, the multilayer ceramic capacitor 10 shown in FIG. 1 is manufactured.

According to the manufacturing method of the multilayer ceramic capacitor according to the present example embodiment, even when the multilayer ceramic capacitor is reduced in thickness, particularly when the multilayer body 12 is reduced in thickness, it is possible to obtain a multilayer ceramic capacitor capable of reducing or preventing cracks during the mounting process.

An example of a multilayer ceramic capacitor 510 according to another example embodiment of the present invention will be described.

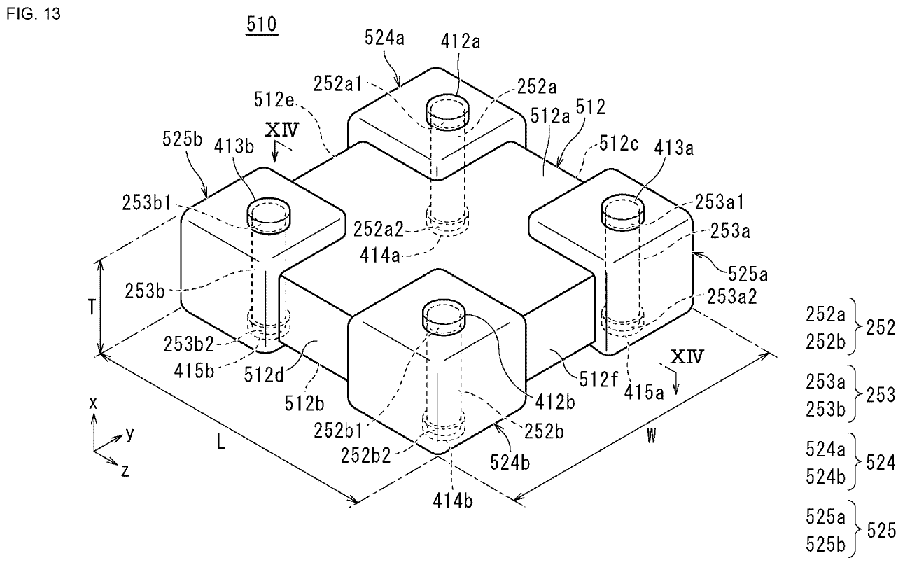

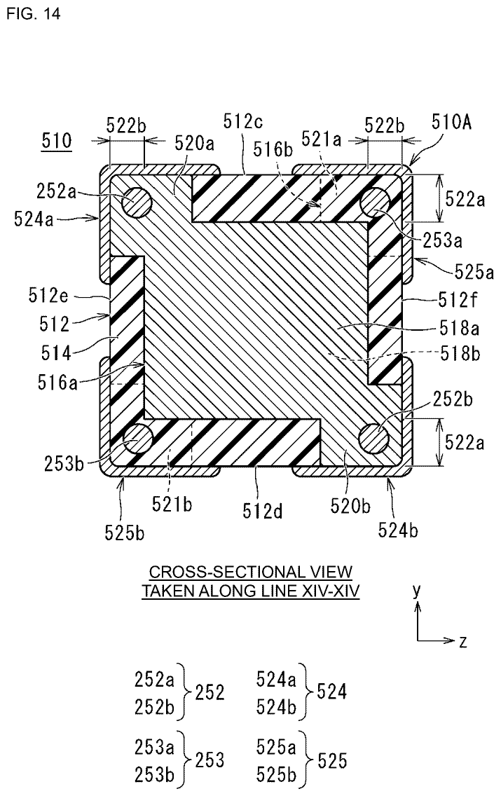

FIG. 13 is an external perspective view showing an example of a multilayer ceramic capacitor according to another example embodiment of the present invention. FIG. 14 is a schematic cross-sectional view taken along line XIV-XIV in FIG. 13.

The multilayer ceramic capacitor 510 shown in FIG. 13 includes a multilayer body 512 and outer electrodes 524 and 525.

The multilayer body 512 includes a plurality of dielectric layers 514 and a plurality of inner electrode layers 516. The multilayer body 512 includes a first main surface 512a and a second main surface 512b facing each other in a height direction x, a first side surface 512c and a second side surface 512d facing each other in a width direction y orthogonal to the height direction x, and a third side surface 512e and a fourth side surface 512f facing each other in a length direction z orthogonal to both the height direction x and the width direction y. The first main surface 512a and the second main surface 512b each extend in the width direction y and the length direction z. The first side surface 512c and the second side surface 512d each extend in the height direction x and the width direction y. The third side surface 512e and the fourth side surface 512f each extend in the height direction x and the length direction z. Accordingly, the height direction x is a direction connecting the first main surface 512a and the second main surface 512b, the width direction y is a direction connecting the first side surface 512c and the second side surface 512d, and the length direction z is a direction connecting the third side surface 512e and the fourth side surface 512f.

The multilayer body 512 is preferably rounded at corners and ridges. Here, the term “corner” refers to a portion where three surfaces of the multilayer body 512 intersect, and the term “ridge” refers to a portion where two surfaces of the multilayer body 512 intersect.

The multilayer body 512 includes, in the height direction x connecting the first main surface 512a and the second main surface 512b, an effective layer portion in which the plurality of inner electrode layers 516 face each other, a first outer layer portion formed of a plurality of dielectric layers 514 located between an inner electrode layer 516 closest to the first main surface 512a side and the first main surface 512a, and a second outer layer portion formed of a plurality of dielectric layers 514 located between an inner electrode layer 516 closest to the second main surface 512b side and the second main surface 512b.

The first outer layer portion is located on the first main surface 512a side of the multilayer body 512, and is an aggregate of the plurality of dielectric layers 514 located between the first main surface 512a and the inner electrode layer 516 closest to the first main surface 512a.

The second outer layer portion is located on the second main surface 512b side of the multilayer body 512, and is an aggregate of the plurality of dielectric layers 514 located between the second main surface 512b and the inner electrode layer 516 closest to the second main surface 512b.

A region sandwiched between the first outer layer portion and the second outer layer portion is an effective layer portion 515a.

The thickness of each of a first outer layer portion 515b1 and the second outer layer portion is preferably 3 μm or more and 15 μm or less. The region sandwiched between both outer layer portions is the effective layer portion. That is, the effective layer portion is a region in which the inner electrode layers 516 are stacked.

The dielectric layers 514 may be formed of, for example, a dielectric material. A dielectric ceramic including BaTiO₃, CaTiO₃, SrTiO₃, CaZrO₃, or the like, as a main component, can be used as the dielectric material. Alternatively, a dielectric ceramic added with sub-components, in addition to the main component, may be used as the dielectric material, wherein examples of the sub-components include Mn compounds, Fe compounds, Cr compounds, Co compounds, and Ni compounds.

As shown in FIG. 14, the inner electrode layers 516 include a plurality of first inner electrode layers 516a and a plurality of second inner electrode layers 516b. The first inner electrode layers 516a and the second inner electrode layers 516b are alternately stacked with the dielectric layers 514 interposed therebetween.

Each first inner electrode layer 516a is disposed on the surface of a dielectric layer 514. Further, the first inner electrode layers 516a each include a first facing electrode portion 518a facing the second inner electrode layer 516b and facing the first main surface 512a and the second main surface 512b, and are stacked in a direction connecting the first main surface 512a and the second main surface 512b.

Each second inner electrode layer 516b is disposed on the surface of a dielectric layer 514 different from the dielectric layer 514 on which the first inner electrode layer 516a is disposed. The second inner electrode layers 516b each include a second facing electrode portion 518b facing the first main surface 512a and the second main surface 512b, and are stacked in the direction connecting the first main surface 512a and the second main surface 512b.

As shown in FIG. 14, each first inner electrode layer 516a is led out to the first side surface 512c and the third side surface 512e of the multilayer body 512 by a first lead-out electrode portion 520a, and is led out to the second side surface 512d and the fourth side surface 512f of the multilayer body 512 by a second lead-out electrode portion 520b. The width by which the first lead-out electrode portion 520a is led out to the first side surface 512c may be substantially equal to the width by which the first lead-out electrode portion 520a is led out to the third side surface 512e, and the width by which the second lead-out electrode portion 520b is led out to the second side surface 512d may be substantially equal to the width by which the second lead-out electrode portion 520b is led out to the fourth side surface 512f.

That is, the first lead-out electrode portion 520a is led out toward the third side surface 512e side of the multilayer body 512, and the second lead-out electrode portion 520b is led out toward the fourth side surface 512f side of the multilayer body 512.

Each second inner electrode layer 516b is led out to the first side surface 512c and the fourth side surface 512f of the multilayer body 512 by a third lead-out electrode portion 521a, and is led out to the second side surface 512d and the third side surface 512e of the multilayer body 512 by a fourth lead-out electrode portion 521b. The width by which the third lead-out electrode portion 521a is led out to the first side surface 512c may be substantially equal to the width by which the third lead-out electrode portion 521a is led out to the fourth side surface 512f, and the width by which the fourth lead-out electrode portion 521b is led out to the second side surface 512d may be substantially equal to the width by which the fourth lead-out electrode portion 521b is led out to the third side surface 512e.

That is, the third lead-out electrode portion 521a is led out toward the fourth side surface 512f side of the multilayer body 512, and the fourth lead-out electrode portion 521b is led out toward the second side surface 512d side of the multilayer body 512.

Further, it is preferable that, when the multilayer ceramic capacitor 510 is viewed from the stacking direction, a straight line connecting the first lead-out electrode portions 520a and the second lead-out electrode portions 520b of the first inner electrode layers 516a and a straight line connecting the third lead-out electrode portions 521a and the fourth lead-out electrode portions 521b of the second inner electrode layers 516b intersect.

Further, it is preferable that, on the side surfaces 512c, 512d, 512e, and 512f of the multilayer body 512, the first lead-out electrode portions 520a of the first inner electrode layers 516a and the fourth lead-out electrode portions 521b of the second inner electrode layers 516b be led out at positions facing each other, and the second lead-out electrode portions 520b of the first inner electrode layers 516a and the third lead-out electrode portions 521a of the second inner electrode layers 516b be led out at positions facing each other.

As shown in FIG. 14, the multilayer body 512 includes side portions (L-gaps) 522b of the multilayer body 512 formed between one end of the first facing electrode portions 518a in the length direction z and the third side surface 512e and between the other end of the second facing electrode portions 518b in the length direction z and the fourth side surface 512f.

Further, as shown in FIG. 14, the multilayer body 512 includes side portions (W-gaps) 522a of the multilayer body 512 formed between one end of the first facing electrode portions 518a in the width direction y and the first side surface 512c and between the other end of the second facing electrode portions 518b in the width direction y and the second side surface 512d.

For example, a metal such as Ni, Cu, Ag, Pd, or Au, or an alloy such as an Ag—Pd alloy including one of these metals can be used as the material of the inner electrode layers 516. The inner electrode layers 516 may further include dielectric particles of the same composition as the ceramics included in the dielectric layers 514.

Further, the first inner electrode layers 516a and the second inner electrode layers 516b may include Sn. By including Sn in the first inner electrode layers 516a and the second inner electrode layers 516b, a potential barrier height at the interfaces between the first inner electrode layers 516a and the second inner electrode layers 516b and the dielectric layers 514 can be increased and a depletion layer thickness can be increased. Thus, electric field concentration at the interfaces can be alleviated, thereby improving high-temperature load reliability. In such a case, sufficient effects can be achieved even if Sn is included only in one of the first inner electrode layers 516a and the second inner electrode layers 516b.

Via conductors 252 are disposed on a corner side formed by the first side surface 512c and the third side surface 512e of the multilayer body 512 and on a corner side formed by the second side surface 512d and the fourth side surface 512f of the multilayer body 512. Via conductors 253 are disposed on a corner side formed by the first side surface 512c and the fourth side surface 512f of the multilayer body 512 and on a corner side formed by the second side surface 512d and the third side surface 512e of the multilayer body 512.

The via conductors 252 include a first via conductor 252a and a second via conductor 252b.

The first via conductor 252a passes through a portion on the corner side of the multilayer body 512 formed by the first side surface 512c and the third side surface 512e in the height direction x, with one end thereof, as a first upper protruding end 252a1, protruding from the first main surface 512a, and the other end thereof, as a first lower protruding end 252a2, protruding from the second main surface 512b.

Within the multilayer body 512, the first via conductor 252a passes through an end portion 522b that includes only the first lead-out electrode portions 520a of the first inner electrode layers 516a, when viewed in the height direction x. In such a case, the first via conductor 252a is electrically connected to the first lead-out electrode portions 520a of the first inner electrode layers 516a.

The end-surface shape of the first via conductor 252a is preferably circular when viewed in the height direction x. However, the end-surface shape of the first via conductor 252a may alternatively be elliptical, oblong, or any other shape. When the end-surface shape of the first via conductor 252a is circular, the diameter thereof is preferably at least in a range of about 6 μm or more and about 100 μm or less, for example. When the end-surface shape of the first via conductor 252a is elliptical, the minor axis thereof is preferably in a range of about 6 μm or more and about 100 μm or less, for example.

The amount by which the first upper protruding end 252a1 of the first via conductor 252a protrudes from the first main surface 512a is preferably about 5 μm or more and about 20 μm or less, for example. The amount by which the first lower protruding end 252a2 of the first via conductor 252a protrudes from the second main surface 512b is preferably about 5 μm or more and about 20 μm or less, for example.

The second via conductor 252b passes through a portion on the corner side of the multilayer body 512 formed by the second side surface 512d and the fourth side surface 512f in the height direction x, with one end thereof, as a second upper protruding end 252b1, protruding from the first main surface 512a, and the other end thereof, as a second lower protruding end 252b2, protruding from the second main surface 512b.

Within the multilayer body 512, the second via conductor 252b passes through an end portion 522b that includes only the second lead-out electrode portions 520b of the first inner electrode layers 516a, when viewed in the height direction x. In such a case, the second via conductor 252b is electrically connected to the second lead-out electrode portions 520b of the first inner electrode layers 516a.

The end-surface shape of the second via conductor 252b is preferably circular when viewed in the height direction x. However, the end-surface shape of the second via conductor 252b may alternatively be elliptical, oblong, or any other shape. When the end-surface shape of the second via conductor 252b is circular, the diameter thereof is preferably at least in a range of about 6 μm or more and about 100 μm or less, for example. When the end-surface shape of the second via conductor 252b is elliptical, the minor axis thereof is preferably in a range of about 6 μm or more and about 100 μm or less, for example.

The amount by which the second upper protruding end 252b1 of the second via conductor 252b protrudes from the first main surface 512a is preferably about 5 μm or more and about 20 μm or less, for example. The amount by which the second lower protruding end 252b2 of the second via conductor 252b protrudes from the second main surface 512b is preferably about 5 μm or more and about 20 μm or less, for example.

The via conductors 253 include a third via conductor 253a and a fourth via conductor 253b.

The third via conductor 253a passes through a portion on the corner side of the multilayer body 512 formed by the first side surface 512c and the fourth side surface 512f in the height direction x, with one end thereof, as a third upper protruding end 253a1, protruding from the first main surface 512a, and the other end thereof, as a third lower protruding end 253a2, protruding from the second main surface 512b.

Within the multilayer body 512, the third via conductor 253a passes through an end portion 522b that includes only the third lead-out electrode portions 521a of the second inner electrode layers 516b, when viewed in the height direction x. In such a case, the third via conductor 253a is electrically connected to the third lead-out electrode portions 521a of the second inner electrode layers 516b.

The end-surface shape of the third via conductor 253a is preferably circular when viewed in the height direction x. However, the end-surface shape of the third via conductor 253a may alternatively be elliptical, oblong, or any other shape. When the end-surface shape of the third via conductor 253a is circular, the diameter thereof is preferably at least in a range of about 6 μm or more and about 100 μm or less, for example. When the end-surface shape of the third via conductor 253a is elliptical, the minor axis thereof is preferably in a range of about 6 μm or more and about 100 μm or less, for example.

The amount by which the third upper protruding end 253a1 of the third via conductor 253a protrudes from the first main surface 512a is preferably about 5 μm or more and about 20 μm or less, for example. The amount by which the third lower protruding end 253a2 of the third via conductor 253a protrudes from the second main surface 512b is preferably about 5 μm or more and about 20 μm or less, for example.

The fourth via conductor 253b passes through a portion on the corner side of the multilayer body 512 formed by the second side surface 512d and the third side surface 512e in the height direction x, with one end thereof, as the fourth upper protruding end 253b1, protruding from the first main surface 512a, and the other end thereof, as a fourth lower protruding end 253b2, protruding from the second main surface 512b.

Within the multilayer body 512, the fourth via conductor 253b passes through an end portion 522b that includes only the fourth lead-out electrode portions 521b of the second inner electrode layers 516b, when viewed in the height direction x. In such a case, the fourth via conductor 253b is electrically connected to the fourth lead-out electrode portions 521b of the second inner electrode layers 516b.

The end-surface shape of the fourth via conductor 253b is preferably circular when viewed in the height direction x. However, the end-surface shape of the fourth via conductor 253b may alternatively be elliptical, oblong, or any other shape. When the end-surface shape of the fourth via conductor 253b is circular, the diameter thereof is preferably at least in a range of about 6 μm or more and about 100 μm or less, for example. When the end-surface shape of the fourth via conductor 253b is elliptical, the minor axis thereof is preferably in a range of about 6 μm or more and about 100 μm or less, for example.

The amount by which the fourth upper protruding end 253b1 of the fourth via conductor 253b protrudes from the first main surface 512a is preferably about 5 μm or more and about 20 μm or less, for example. The amount by which the fourth lower protruding end 253b2 of the fourth via conductor 253b protrudes from the second main surface 512b is preferably about 5 μm or more and about 20 μm or less, for example.

The via conductors 252 and 253 may be formed of, for example, a conductive paste including conductive metal powder having Ag, Cu, or Ni as a main component.

As shown in FIG. 13, the outer electrodes 524 and 525 are disposed on the multilayer body 512.

The outer electrode 524 includes a first outer electrode 524a and a second outer electrode 524b.

The first outer electrode 524a covers, on the first side surface 512c and the third side surface 512e, the first lead-out electrode portions 520a, and covers a portion of the first main surface 512a and a portion of the second main surface 512b. The first outer electrode 524a is electrically connected to the first lead-out electrode portions 520a of the first inner electrode layers 516a.

The second outer electrode 524b covers, on the second side surface 512d and the fourth side surface 512f, the second lead-out electrode portions 520b, and covers a portion of the first main surface 512a and a portion of the second main surface 512b. The second outer electrode 524b is electrically connected to the second lead-out electrode portions 520b of the first inner electrode layers 516a.

The outer electrode 525 includes a third outer electrode 525a and a fourth outer electrode 525b.

The third outer electrode 525a covers, on the first side surface 512c and the fourth side surface 512f, the third lead-out electrode portions 521a, and covers a portion of the first main surface 512a and a portion of the second main surface 512b. The third outer electrode 525a is electrically connected to the third lead-out electrode portions 521a of the second inner electrode layers 516b.

The fourth outer electrode 525b covers, on the second side surface 512d and the third side surface 512e, the fourth lead-out electrode portions 521b, and covers a portion of the first main surface 512a and a portion of the second main surface 512b. The fourth outer electrode 525b is electrically connected to the fourth lead-out electrode portions 521b of the second inner electrode layers 516b.

In the multilayer body 512, electrostatic capacitance is formed by the first facing electrode portions 518a of the first inner electrode layers 516a and the second facing electrode portions 518b of the second inner electrode layers 516b facing each other with the dielectric layers 514 interposed therebetween. Therefore, electrostatic capacitance can be obtained between the first outer electrode 524a and the second outer electrode 524b, to both of which the first inner electrode layers 516a are connected, and the third outer electrode 525a and the fourth outer electrode 525b, to both of which the second inner electrode layers 516b are connected, thus exhibiting capacitor characteristics.

The first outer electrode 524a covers the first upper protruding end 252a1 of the first via conductor 252a protruding from the first main surface 512a of the multilayer body 512. In the first outer electrode 524a, a portion covering the first upper protruding end 252a1 includes a first upper protruding portion 412a protruding more than other portions covering the first main surface 512a. Thus, the first outer electrode 524a protrudes from the surface in accordance with the shape of the first upper protruding end 252a1.

The first outer electrode 524a covers the first lower protruding end 252a2 of the first via conductor 252a protruding from the second main surface 512b of the multilayer body 512. In the first outer electrode 524a, a portion covering the first lower protruding end 252a2 includes a first lower protruding portion 414a protruding more than other portions covering the second main surface 512b. Thus, the first outer electrode 524a protrudes from the surface in accordance with the shape of the first lower protruding end 252a2.

The second outer electrode 524b covers the second upper protruding end 252b1 of the second via conductor 252b protruding from the first main surface 512a of the multilayer body 512. In the second outer electrode 524b, a portion covering the second upper protruding end 252b1 includes a second upper protruding portion 412b protruding more than other portions covering the first main surface 512a. Thus, the second outer electrode 524b protrudes from the surface in accordance with the shape of the second upper protruding end 252b1.

The second outer electrode 524b covers the second lower protruding end 252b2 of the second via conductor 252b protruding from the second main surface 512b of the multilayer body 512. In the second outer electrode 524b, a portion covering the second lower protruding end 252b2 includes a second lower protruding portion 414b protruding more than other portions covering the second main surface 512b. Thus, the second outer electrode 524b protrudes from the surface in accordance with the shape of the second lower protruding end 252b2.

The third outer electrode 525a covers the third upper protruding end 253a1 of the third via conductor 253a protruding from the first main surface 512a of the multilayer body 512. In the third outer electrode 525a, a portion covering the third upper protruding end 253a1 includes a third upper protruding portion 413a protruding more than other portions covering the first main surface 512a. Thus, the third outer electrode 525a protrudes from the surface in accordance with the shape of the third upper protruding end 253a1.

The third outer electrode 525a covers the third lower protruding end 253a2 of the third via conductor 253a protruding from the second main surface 512b of the multilayer body 512. In the third outer electrode 525a, a portion covering the third lower protruding end 253a2 includes a third lower protruding portion 415a protruding more than other portions covering the second main surface 512b. Thus, the third outer electrode 525a protrudes from the surface in accordance with the shape of the third lower protruding end 253a2.

The fourth outer electrode 525b covers the fourth upper protruding end 253b1 of the fourth via conductor 253b protruding from the first main surface 512a of the multilayer body 512. In the fourth outer electrode 525b, a portion covering the fourth upper protruding end 253b1 includes a fourth upper protruding portion 413b protruding more than other portions covering the first main surface 512a. Thus, the second outer electrode 524b protrudes from the surface in accordance with the shape of the fourth upper protruding end 253b1.

The fourth outer electrode 525b covers the fourth lower protruding end 253b2 of the fourth via conductor 253b protruding from the second main surface 512b of the multilayer body 512. In the fourth outer electrode 525b, a portion covering the fourth lower protruding end 253b2 includes a fourth lower protruding portion 415b protruding more than other portions covering the second main surface 512b. Thus, the fourth outer electrode 525b protrudes from the surface in accordance with the shape of the fourth lower protruding end 253b2.

The first upper protruding portion 412a, the first lower protruding portion 414a, the second upper protruding portion 412b, and the second lower protruding portion 414b each preferably have a dimension of 5 μm or more from each surface in the height direction x. Further, in such a case, it is preferable that a height of the first upper protruding portion 412a specified by the protruding amount of the first upper protruding end 252a1 of the first via conductor 252a and the thickness of the first outer electrode 524a be equal to a height of the second upper protruding portion 412b specified by the protruding amount of the second upper protruding end 252b1 of the second via conductor 252b and the thickness of the second outer electrode 524b; and it is preferable that a height of the first lower protruding portion 414a specified by the protruding amount of the first lower protruding end 252a2 of the first via conductor 252a and the thickness of the first outer electrode 524a be equal to a height of the second lower protruding portion 414b specified by the protruding amount of the second lower protruding end 252b2 of the second via conductor 252b and the thickness of the second outer electrode 524b.

The third upper protruding portion 413a, the third lower protruding portion 415a, the fourth upper protruding portion 413b, and the fourth lower protruding portion 415b each preferably have a dimension of about 5 μm or more from each surface in the height direction x, for example. Further, in such a case, it is preferable that a height of the third upper protruding portion 413a specified by the protruding amount of the third upper protruding end 253a1 of the third via conductor 253a and the thickness of the third outer electrode 525a be equal to a height of the fourth upper protruding portion 413b specified by the protruding amount of the fourth upper protruding end 253b1 of the fourth via conductor 253b and the thickness of the fourth outer electrode 525b. Also, it is preferable that a height of the third lower protruding portion 415a specified by the protruding amount of the third lower protruding end 253a2 of the third via conductor 253a and the thickness of the third outer electrode 525a be equal to a height of the fourth lower protruding portion 415b specified by the protruding amount of the fourth lower protruding end 253b2 of the fourth via conductor 253b and the thickness of the fourth outer electrode 525b.

The structure of the outer electrodes of the multilayer ceramic capacitor 510 according to the present example embodiment may be combined with an entirety or a portion of the multilayer ceramic capacitor 10 according to the example embodiment described with reference to FIGS. 1 to 7 and the modifications thereof (i.e., the first modification to the third modification).

The dimension of the multilayer ceramic capacitor 510 that includes the multilayer body 512 and the outer electrodes 524 and 525, in the length direction z, is defined as an L-dimension, the dimension of the multilayer ceramic capacitor 510 that includes the multilayer body 512 and the outer electrodes 524 and 525, in the height direction x, is defined as a T-dimension, and the dimension of the multilayer ceramic capacitor 510 that includes the multilayer body 12 and the outer electrodes 524 and 525, in the width direction y, is defined as a W-dimension. The dimensions of the multilayer ceramic capacitor 510 are preferably such that the L-dimension in the length direction z is about 0.1 mm or more and about 6.0 mm or less and the W-dimension in the width direction y is about 0.1 mm or more and about 6.0 mm or less, for example. Here, about 7/10≤L/W≤about 10/7 is preferable, for example. With such a configuration, the multilayer ceramic capacitor includes a substantially tetragonal shape, thus increasing mounting flexibility.

Thus, the multilayer ceramic capacitor 510 can achieve the same effects as the multilayer ceramic capacitor 10 shown in FIG. 1.

As described above, the example embodiments of the present invention have been disclosed in the foregoing description; however, the present invention is not limited to such example embodiments.

That is, various changes can be made to the above-described example embodiments and modifications with respect to mechanisms, shapes, materials, quantities, positions, arrangements, and the like without departing from the scope of the technical ideas and concepts of the present invention, and such changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body that includes a plurality of stacked dielectric layers, a first main surface and a second main surface facing each other in a stacking direction of the plurality of dielectric layers, a first side surface and a second side surface facing each other in a width direction orthogonal to the stacking direction, a first end surface and a second end surface facing each other in a length direction orthogonal to both the stacking direction and the width direction, a first inner electrode layers alternately stacked with the plurality of dielectric layers, and a second inner electrode layers alternately stacked with the plurality of dielectric layers;
a first outer electrode covering at least a portion of each of the first main surface and the second main surface of the multilayer body;
a second outer electrode covering at least a portion of each of the first main surface and the second main surface of the multilayer body;
a first via conductor passing through the multilayer body in the stacking direction of the plurality of dielectric layers and connected to the first inner electrode layer; and
a second via conductor passing through the multilayer body in the stacking direction of the plurality of dielectric layers and connected to the second inner electrode layer; wherein
the first via conductor includes a first upper protruding end protruding from the first main surface and a first lower protruding end protruding from the second main surface;
the second via conductor includes a second upper protruding end protruding from the first main surface and a second lower protruding end protruding from the second main surface;
the first outer electrode covers the first upper protruding end and the first lower protruding end of the first via conductor;
the second outer electrode covers the second upper protruding end and the second lower protruding end of the second via conductor;
in the first outer electrode, a portion covering the first upper protruding end of the first via conductor includes a first upper protruding portion protruding more than other portions covering the first main surface, and a portion covering the first lower protruding end of the first via conductor includes a first lower protruding portion protruding more than other portions covering the second main surface; and
in the second outer electrode, a portion covering the second upper protruding end of the second via conductor includes a second upper protruding portion protruding more than other portions covering the first main surface, and a portion covering the second lower protruding end of the second via conductor includes a second lower protruding portion protruding more than other portions covering the second main surface.

2. The multilayer ceramic capacitor according to claim 1, wherein
the first outer electrode also covers the first end surface;
the second outer electrode also covers the second end surface;
in the first outer electrode, a portion covering a portion of the first main surface, a portion covering a portion of the second main surface, and a portion covering the first end surface are spaced apart from each other; and
in the second outer electrode, a portion covering a portion of the first main surface, a portion covering a portion of the second main surface, and a portion covering the second end surface are spaced apart from each other.

3. The multilayer ceramic capacitor according to claim 1, wherein
a dimension by which the first upper protruding end of the first via conductor protrudes from the first main surface is about 5 μm or more and about 20 μm or less;
a dimension by which the first lower protruding end of the first via conductor protrudes from the second main surface is about 5 μm or more and about 20 μm or less;
a dimension by which the second upper protruding end of the second via conductor protrudes from the first main surface is about 5 μm or more and about 20 μm or less; and
a dimension by which the second lower protruding end of the second via conductor protrudes from the second main surface is about 5 μm or more and about 20 μm or less.

4. The multilayer ceramic capacitor according to claim 1, wherein
a dimension by which the first upper protruding portion of the first outer electrode protrudes from the other portions covering the first main surface is about 5 μm or more;
a dimension by which the first lower protruding portion of the first outer electrode protrudes from the other portions covering the second main surface is about 5 μm or more;
a dimension by which the second upper protruding portion of the second outer electrode protrudes from the other portions covering the first main surface is about 5 μm or more; and
a dimension by which the second lower protruding portion of the second outer electrode protrudes from the other portions covering the second main surface is about 5 μm or more.

5. The multilayer ceramic capacitor according to claim 1, wherein the multilayer body includes rounded corners and rounded ridges.

6. The multilayer ceramic capacitor according to claim 1, wherein the multilayer body includes end gaps or side gaps.

7. The multilayer ceramic capacitor according to claim 1, wherein an end surface shape of each of the first via conductor and the second via conductor is circular, elliptical, or oblong.

8. The multilayer ceramic capacitor according to claim 1, wherein a diameter of an end surface shape of each of the first via conductor and the second via conductor is about 6 μm or more and about 100 μm or less.

9. The multilayer ceramic capacitor according to claim 1, wherein each of the first outer electrode and the second outer electrode includes a base electrode layer and a plating layer.

10. The multilayer ceramic capacitor according to claim 9, wherein the base electrode layer includes an upper base electrode layer and a lower base electrode layer, and the plating layer includes an upper plating layer and a lower plating layer.

11. A multilayer ceramic capacitor comprising:
a multilayer body that includes a plurality of stacked dielectric layers, a first main surface and a second main surface facing each other in a stacking direction of the plurality of dielectric layers, a first side surface and a second side surface facing each other in a width direction orthogonal to the stacking direction, a third side surface and a fourth side surface facing each other in a length direction orthogonal to both the stacking direction and the width direction, a first inner electrode layer alternately stacked with the plurality of dielectric layers, and a second inner electrode layer alternately stacked with the plurality of dielectric layers;
a first outer electrode covering at least the first main surface and the second main surface of the multilayer body;
a second outer electrode covering at least the first main surface and the second main surface of the multilayer body;
a third outer electrode covering at least the first main surface and the second main surface of the multilayer body;
a fourth outer electrode covering at least the first main surface and the second main surface of the multilayer body;
a first via conductor and a second via conductor each passing through the multilayer body in the stacking direction of the plurality of dielectric layers and connected to the first inner electrode layer; and
a third via conductor and a fourth via conductor each passing through the multilayer body in the stacking direction of the plurality of dielectric layers and connected to the second inner electrode layer; wherein
the first via conductor includes a first upper protruding end protruding from the first main surface and a first lower protruding end protruding from the second main surface;
the second via conductor includes a second upper protruding end protruding from the first main surface and a second lower protruding end protruding from the second main surface;
the third via conductor includes a third upper protruding end protruding from the first main surface and a third lower protruding end protruding from the second main surface;
the fourth via conductor includes the fourth upper protruding end protruding from the first main surface and a fourth lower protruding end protruding from the second main surface;
the first outer electrode covers the first upper protruding end and the first lower protruding end of the first via conductor;
the second outer electrode covers the second upper protruding end and the second lower protruding end of the second via conductor;
the third outer electrode covers the third upper protruding end and the third lower protruding end of the third via conductor;
the fourth outer electrode covers the fourth upper protruding end and the fourth lower protruding end of the fourth via conductor;
in the first outer electrode, a portion covering the first upper protruding end of the first via conductor includes a first upper protruding portion protruding more than other portions covering the first main surface, and a portion covering the first lower protruding end of the first via conductor includes a first lower protruding portion protruding more than other portions covering the second main surface;
in the second outer electrode, a portion covering the second upper protruding end of the second via conductor includes a second upper protruding portion protruding more than other portions covering the first main surface, and a portion covering the second lower protruding end of the second via conductor includes a second lower protruding portion protruding more than other portions covering the second main surface;
in the third outer electrode, a portion covering the third upper protruding end of the third via conductor includes a third upper protruding portion protruding more than other portions covering the first main surface, and a portion covering the third lower protruding end of the third via conductor includes a third lower protruding portion protruding more than other portions covering the second main surface; and
in the fourth outer electrode, a portion covering the fourth upper protruding end of the fourth via conductor includes a fourth upper protruding portion protruding more than other portions covering the first main surface, and a portion covering the fourth lower protruding end of the fourth via conductor includes a fourth lower protruding portion protruding more than other portions covering the second main surface.

12. The multilayer ceramic capacitor according to claim 11, wherein
the first outer electrode also covers the first end surface;
the second outer electrode also covers the second end surface;
in the first outer electrode, a portion covering a portion of the first main surface, a portion covering a portion of the second main surface, and a portion covering the first end surface are spaced apart from each other; and
in the second outer electrode, a portion covering a portion of the first main surface, a portion covering a portion of the second main surface, and a portion covering the second end surface are spaced apart from each other.

13. The multilayer ceramic capacitor according to claim 11, wherein
a dimension by which the first upper protruding end of the first via conductor protrudes from the first main surface is about 5 μm or more and about 20 μm or less;
a dimension by which the first lower protruding end of the first via conductor protrudes from the second main surface is about 5 μm or more and about 20 μm or less;
a dimension by which the second upper protruding end of the second via conductor protrudes from the first main surface is about 5 μm or more and about 20 μm or less; and
a dimension by which the second lower protruding end of the second via conductor protrudes from the second main surface is about 5 μm or more and about 20 μm or less.

14. The multilayer ceramic capacitor according to claim 11, wherein
a dimension by which the first upper protruding portion of the first outer electrode protrudes from the other portions covering the first main surface is about 5 μm or more;
a dimension by which the first lower protruding portion of the first outer electrode protrudes from the other portions covering the second main surface is about 5 μm or more;
a dimension by which the second upper protruding portion of the second outer electrode protrudes from the other portions covering the first main surface is about 5 μm or more; and
a dimension by which the second lower protruding portion of the second outer electrode protrudes from the other portions covering the second main surface is about 5 μm or more.

15. The multilayer ceramic capacitor according to claim 11, wherein the multilayer body includes rounded corners and rounded ridges.

16. The multilayer ceramic capacitor according to claim 11, wherein the multilayer body includes end gaps or side gaps.

17. The multilayer ceramic capacitor according to claim 11, wherein an end surface shape of each of the first via conductor and the second via conductor is circular, elliptical, or oblong.

18. The multilayer ceramic capacitor according to claim 11, wherein a diameter of an end surface shape of each of the first via conductor and the second via conductor is about 6 μm or more and about 100 μm or less.

19. The multilayer ceramic capacitor according to claim 11, wherein each of the first outer electrode, the second outer electrode, the third outer electrode, and the fourth outer electrode includes a base electrode layer and a plating layer.

20. The multilayer ceramic capacitor according to claim 19, wherein the base electrode layer includes an upper base electrode layer and a lower base electrode layer, and the plating layer includes an upper plating layer and a lower plating layer.
